(19) United States
(12) Patent Application Publication
(10) Pub. No.: US 2006/0294255 A1
(43) Pub. Date: Dec. 28, 2006

(54) Support system for standard operation procedure

(75) Inventor: Tsung-Chun Chen, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/165,134

(22) Filed: Jun. 24, 2005

(51) Int. Cl. G06F 9/46; G06F 15/173

(52) U.S. Cl. 709/240; 718/100

(57) ABSTRACT

The present invention discloses a support system for a standard operation procedure, which comprises: a task database, recording the task-related information of the operation procedure; user ends, having information-display interfaces to present the information of the operation procedure; and an operation procedure distribution server, communicatively connected to the task database, reading corresponding data of the operation procedure from the task database according to an assigned task, distributing and transmitting the obtained data to the user ends via a communication network. The support system for a standard operation procedure of the present invention can realize the electronic and information-based data for a standard operation procedure, can direct different users to cooperate to complete a task, and can improve the problems of the conventional method that paper documents of operation procedure information are issued by man.

### FIELD OF THE INVENTION

The present invention relates to an information distribution system, particularly to a support system for a standard operation procedure, which realizes the electronic and information-based data for the standard operation procedure of a production line, and distributes and transmits the data to the user end.

### BACKGROUND OF THE INVENTION

In general, a Standard Operation Procedure (SOP) is defined as “a written document describing the execution process of a routine or repeated task in detail, such as various inspections and operations, in order to standardize and uniformize the procedure of the task”. In other words, the basic concept of SOP is to standardize and uinformize the information relating to the operation procedure of some task.

For a fabrication operation, the primary objective of pushing SOP is to lower the defective fraction resulting from human errors, to reduce cost, and to achieve quality uniformity. Exemplified with a production line, the operators at all the stages of a production line cooperate to finish the assembling or manufacturing task of some product according to a scheduled operation procedure; for example, the assembling of some product is completed by the operators of multiple successive workstations together, and the operation contents executed in each workstation is according to a document recording the information of the operation procedure. Traditionally, SOP is recorded in a dead-tree-ware and is issued to every workstation by man, and SOP's of different products are distinguished with part numbers or other identification numbers.

Such a traditional SOP execution method has some disadvantages:
1. planning and making those paper documents expends more time;
2. renewing or updating the contents of those paper documents is slow and inconvenient; the task of a product line tends to be diversified nowadays, and it is hard for a paper document SOP to update or renew its contents when the task is changed or modified;
3. storing and managing those paper documents is not easy.

The U.S. Patent publication No. 20010034756 discloses a laboratory information system, which is of an SOP-oriented system architecture. This laboratory information system can help scientists manage experiment-related routine works and documents. However, this conventional technology does not disclose any technology about supporting or directing multiple operators, such as those in a production line, to cooperate to complete a task.

### SUMMARY OF THE INVENTION

The present invention discloses a support system for a standard operation procedure, which realizes the electronic and information-based data for the standard operation procedure to replace the conventional man-issued paper documents of the operation procedure information.

According to one embodiment of the present invention, the support system for a standard operation procedure comprises: a task database, recording the task-related information of the operation procedure; user ends, having information-display interfaces; and an operation procedure distribution server, communicatively connected to the task database, reading corresponding data of the operation procedure from the task database according to an assigned task, distributing and transmitting the obtained data to the user ends via a communication network. The support system for a standard operation procedure of the present invention can realize the electronic and information-based data for a standard operation procedure and direct different users to cooperate to complete a task, and can improve the problems of the conventional method that the paper documents of operation procedure information are issued by man.

According to the present invention, the system architecture is a N-Tier one, wherein the task database is stored inside a back-end database server, and the operation procedure distribution server is interposed between the back-end database server and the user ends. The operation procedure distribution server reads corresponding data from the task database inside the back-end database server according to the task assigned by the users, distributes and transmits the obtained data to user ends via a communication network.

The preferred embodiments and advantages of the present invention will be further clarified below.

### BRIEF DESCRIPTION OF THE DRAWINGS

FIG. 1 is a diagram of the system architecture according to one embodiment of the present invention.

FIG. 2 is a diagram of the system architecture according to another embodiment of the present invention.

FIG. 3 is a diagram of the system architecture according to further another embodiment of the present invention.

### DETAILED DESCRIPTION OF THE PREFERRED EMBODIMENTS

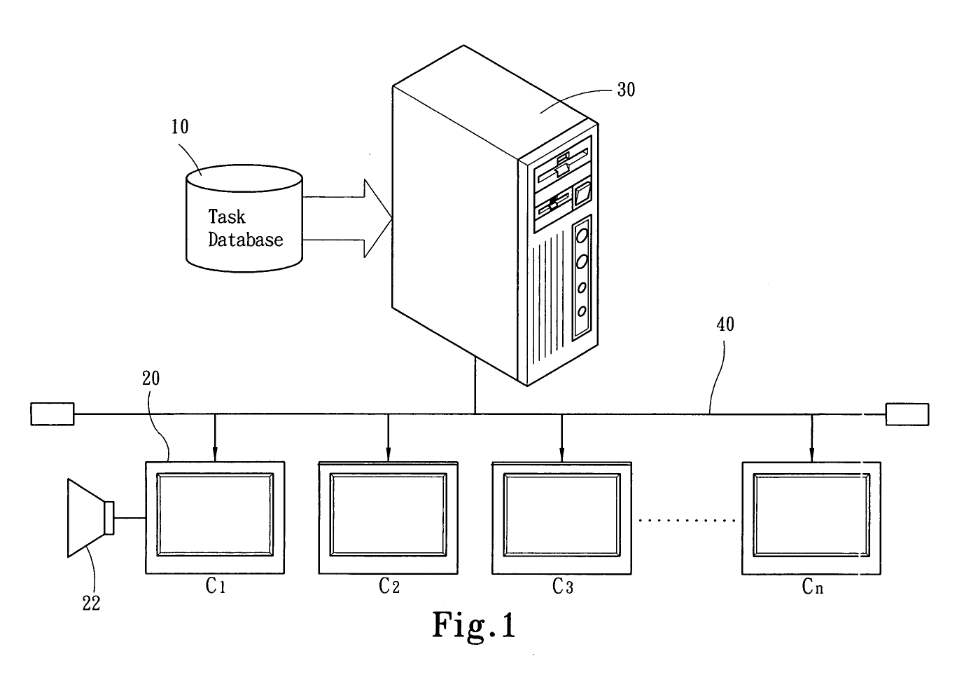

Referring to FIG. 1, the support system for a standard operation procedure according to the present invention, comprises:
a task database 10, recording the task-related information of the operation procedure;
user ends 20, having information-display interfaces 21 to present the information of the operation procedure; and
an operation procedure distribution server 30, communicatively connected to the task database 10 via a communication network 40, reading corresponding data of the operation procedure from the task database 10 according to an assigned task, distributing and transmitting the obtained data to the user ends 20 via the communication network 40, wherein the assigned task is selected by the user ends 20 or the operation procedure distribution server 30.

Exemplified by a production line, the user ends 20 are respectively disposed at workstations C1˜Cn of the production line. Basically, the operators at the workstations C1˜Cn cooperate to finish the assembling or the processing of a product (a finished product or a semi-finished product) according to a scheduled standard operation procedure. For example, the assembling of a product is finished by the cooperation of the operators in successive workstations; the operation of each of the workstations C1˜Cn is according to an “operation procedure data” containing related assembling procedure. The so-called “operation procedure data” may be but is not limited to texts, pictures, drawings, video data, audio signal, multimedia information, or any combination of them. The “operation procedure data” is to provide operation guides and references for any operator of those workstations in order to direct the operators to execute the operations of their own workstations so that the operators of all the workstations can cooperate to complete the assembling task or other tasks.

The information-display interface 21 can be either a CRT (cathode ray tube) display device or a LCD (liquid crystal display) display device. The preferred embodiment of the user end 20 may further comprise an audio output device 22, and the audio output device 22 may be but is not limited to a speaker or its equals. The audio output device 22 can output voice to direct the operators to finish the operations having to be executed in their own workstations C1˜Cn.

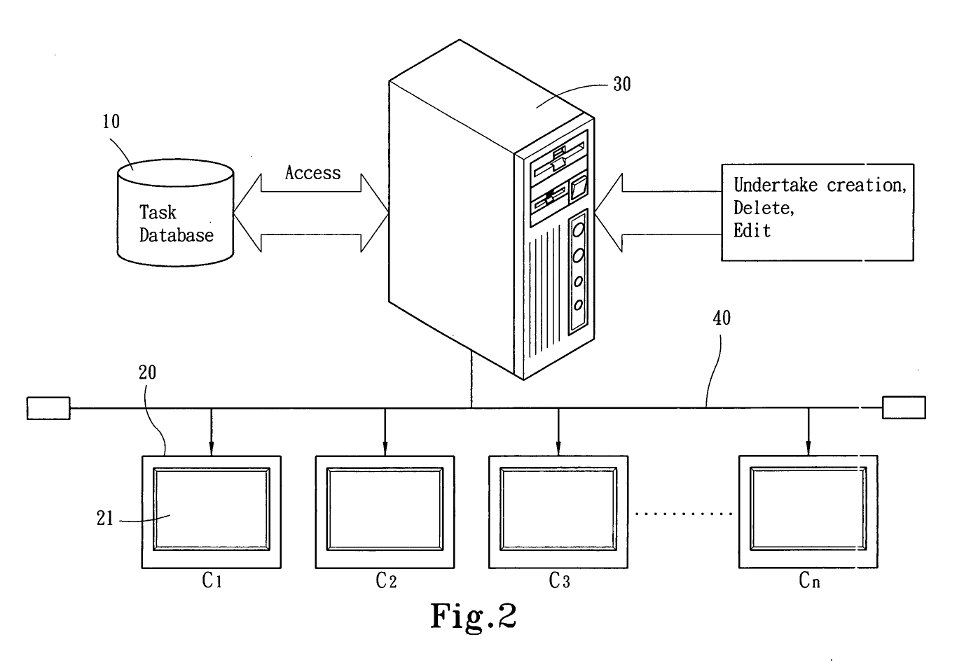

According to one embodiment of the support system for a standard operation procedure of the present invention, the system architecture may be a client/server one. The task database 10 is stored inside a built-in accessible recording medium of the operation procedure distribution server 30, and the recording medium may be but is not limited to a hard disk, an optical disk, or other equals. In the first embodiment shown in FIG. 1, the task database 10 only supports the operation procedure distribution server 30 and provides the required operation procedure data of for it. In the preferred embodiment shown in FIG. 2, via the operation procedure distribution server 30, the maintenance personnel for the operation procedure can undertake creation, deletion, or edition, etc. on any task-related data of the operation procedure, and can arrange beforehand the tasks and related operation procedure data, which are to be issued to the workstations C1˜Cn.

The operation procedure distribution server 30 has a task-distribution mechanism, which can be implemented with software. Basically, each of the workstations C1˜Cn has a specific hardware address, which enables the operation procedure distribution server 30 to issue the operation procedure data for some workstation correctly to that workstation.

The communication network 40 may be an intranet, a LAN (local area network) or the Internet, which meets the wire network standard 802.3 or the wireless network standard 802.11. The communication network 40 can be connected to the workstations C1˜Cn via a hardware communication port, which may be but is not limited to RS-232 or RJ-45. The hardware address of the workstations C1˜Cn can be implemented with TCP/IP protocol or a hardware locator, which the persons skilled in the art can easily realize according to the present invention.

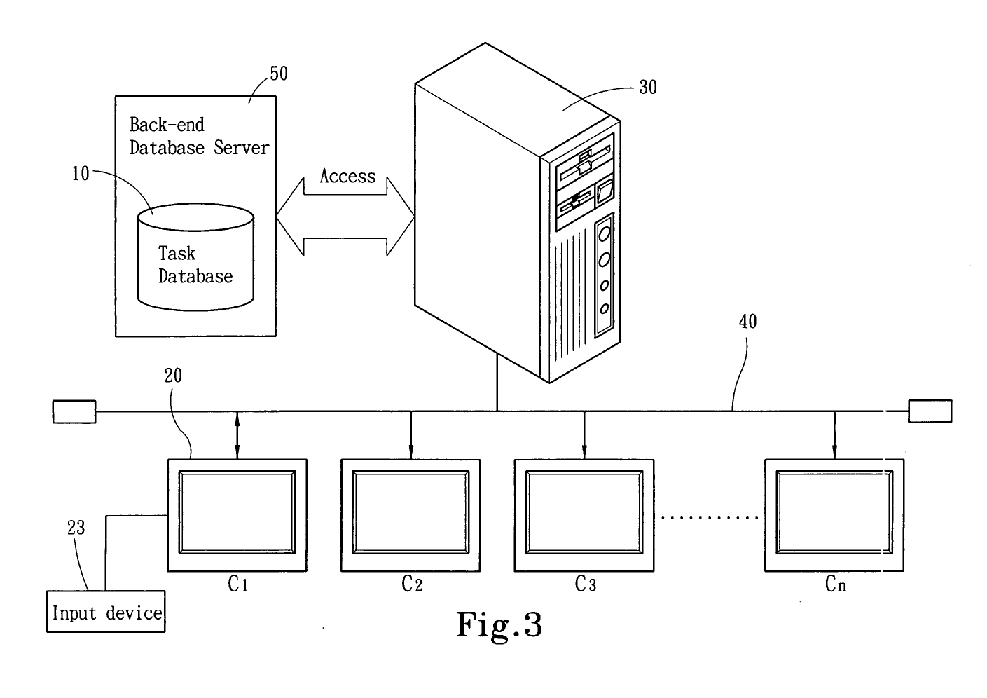

According to another embodiment of the support system for a standard operation procedure of the present invention, the system architecture may also be an N-Tier one. The task database 10 is stored inside a built-in accessible recording medium of a back-end database server 50, as shown in FIG. 3, and the operation procedure distribution server 30 is interposed between the user ends 20 and the back-end database server 50. The operation procedure distribution server 30 reads corresponding data from the task database 10 inside the back-end database server 50 according to the assigned task, distributes and transmits the obtained data to user ends 20 via a communication network 40. Such a 3-tier architecture can support more operation procedure distribution servers 30, and thus, more operation standard procedure can be executed in more production lines.

According to further another embodiment of the support system for a standard operation procedure of the present invention, as shown in FIG. 3, the user end 20 may further comprises an input device 23, via which the operators can input operation instructions to operate the operation procedure data presented by the information-display interface 21. Herein, the aforementioned “operating the operation procedure data” may includes but is not limited to the operation of selection, assignment, page-up/down, zoom-out, zoom-in, sequential play, repeated play, or pause. Besides, when the operators are authorized, they can select different tasks in order to shift the operation standard procedures of some production lines. The input device 23 may be buttons, a touch panel, a cursor controller, or any combination of them. A preferred embodiment thereof may further comprise a graphic user interface (GUI), which can provide the operators with visualized operation environments and promote operation convenience. Further, cooperating with a wireless communication network 40, the information-display interface 21 and/or the input device 23 of the user end 20 may also be a portable device, which includes but is not limited to a notebook computer, a table computer or a personal digital assistant. Owing to the movability of the potable device, the user ends 20 will have superior convenience, flexibility, and expandability for changing the configuration of the user ends.

The preferred embodiments disclosed above are only to clarify the present invention but not intended to limit the scope of the present invention. Any modification and variation according to the spirit of the present invention is to be included within the scope of the present invention.

What is claimed is:

1. A support system for a standard operation procedure, comprising:
a task database, recording the task-related information of an operation procedure;
user ends, having information-display interfaces to present information of said operation procedure; and
an operation procedure distribution server, communicatively connected to said task database; according to an assigned task, obtaining corresponding data of said assigned task from said task database; distributing and transmitting the obtained data to said user ends via a communication network.

2. The support system for a standard operation procedure according to claim 1, wherein the architecture of said support system is a 3-Tier one; said task database is stored inside a back-end database server of said
3-Tier architecture; said operation procedure distribution server is interposed between said user ends and said back-end database server; and said operation procedure distribution server communicates respectively with said user ends and said back-end database server via said communication network.

3. The support system for a standard operation procedure according to claim 1, wherein the architecture of said support system is a client/server one, and said task database is stored inside said operation procedure distribution server.

4. The support system for a standard operation procedure according to claim 1, wherein said information-display interface can be selected from a CRT (cathode ray tube) display device and a LCD (liquid crystal display) display device.

5. The support system for a standard operation procedure according to claim 1, wherein said user end further comprises an input device, via which the operators can input operation instructions.

6. The support system for a standard operation procedure according to claim 5, wherein said input device may be selected from buttons, a touch panel, a cursor controller, and any combination of them.

7. The support system for a standard operation procedure according to claim 6, wherein said input device further comprises a graphic user interface (GUI).

8. The support system for a standard operation procedure according to claim 1, wherein according to the contents of said assigned task, said information of said operation procedure is sequentially distributed and transmitted to at least one user end.

9. The support system for a standard operation procedure according to claim 1, wherein said communication network is a wireless one.

10. The support system for a standard operation procedure according to claim 1, wherein said communication network is a wire one.

11. The support system for a standard operation procedure according to claim 1, wherein said user end is a portable device.

12. The support system for a standard operation procedure according to claim 11, wherein said portable device can be selected from a notebook computer, a table computer, and a personal digital assistant.

13. The support system for a standard operation procedure according to claim 11, wherein said portable device further comprises a liquid crystal display device and an input device.

14. The support system for a standard operation procedure according to claim 13, wherein said input device may be selected from buttons, a touch panel, a cursor controller, and any combination of them.

15. The support system for a standard operation procedure according to claim 1, wherein said information of said operation procedure may be selected from texts, pictures, drawings, video data, audio signal, multimedia information, and any combination of them.
